(19) United States
(12) Patent Application Publication
(10) Pub. No.: US 2026/0199889 A1
(43) Pub. Date: Jul. 16, 2026

(54) ADDITIVELY MANUFACTURED CERAMIC CATALYST SUPPORT

(71) Applicant: Blasch Precision Ceramics, Inc., Menands, NY (US)

(72) Inventors: Keith Joseph DeCarlo, North Greenbush, NY (US); Rehan Afzal, Latham, NY (US); Pierre Francois Pinard, Voorheesville, NY (US); Liam Gabriel Saccucci-Bryan, Schenectady, NY (US)

(21) Appl. No.: 19/021,695

(22) Filed: Jan. 15, 2025

(51) Int. Cl. B01J 35/57; B28B 1/00; B33Y 10/00; B33Y 80/00

(52) U.S. Cl. CPC B01J 35/57; B28B 1/001; B33Y 10/00; B33Y 80/00

(57) ABSTRACT

A printed ceramic catalyst support for a catalytic membrane and method of forming the same. The support includes a plurality of printed ceramic layers, wherein each printed ceramic layer includes a hexagonal grid having a plurality of hexagonal openings, and wherein adjacent printed ceramic layers are offset from each other such that the hexagonal openings of adjacent printed ceramic layers are misaligned; and a plurality of printed ceramic posts that connect adjacent printed ceramic layers.

### BACKGROUND

The disclosure relates generally to an additively manufactured ceramic catalyst support and a method of making the same. In particular, the disclosure relates generally to an additively manufactured ceramic product with staggered layering to support a catalytic membrane.

Ceramic catalyst supports that support catalytic membranes, such as platinum (Pt) or nickel (Ni) catalysts, have been widely used in the chemical industry.

### BRIEF SUMMARY

Aspects of the invention are generally directed to printed ceramic catalyst support for supporting a catalytic membrane and an additive manufacturing method of forming the same.

Certain embodiments are summarized below. These embodiments are not intended to limit the scope of the present disclosure, but rather these embodiments are intended only to provide a brief summary of possible forms of the disclosure. Indeed, the present system and method may encompass a variety of forms that may be similar to or different from the embodiments set forth below.

One aspect provides a catalyst membrane support, comprising: a plurality of printed ceramic layers, wherein each printed ceramic layer includes a grid having a plurality of geometric openings along an x-y plane, and wherein adjacent printed ceramic layers are separated from each other along a z-axis; and a plurality of printed ceramic posts that connect adjacent printed ceramic layers.

A second aspect provides an additive manufacturing (AM) method for producing a catalyst support, comprising: printing a first ceramic layer having a defined grid with a plurality of geometric openings along an x-y plane; printing a plurality of ceramic posts having first ends that connect to and extend along a z-axis from the first ceramic layer; and printing a second ceramic layer having the defined grid that connect to second ends of the ceramic posts.

In some embodiments, printed ceramic layers are offset from each other such that the openings of adjacent printed ceramic layers are misaligned.

A further aspect includes an additive manufacturing (AM) method for producing a catalyst support, comprising printing a first plurality of ceramic substructures, each having a surface adapted for receiving a membrane and having a plurality of openings, wherein each ceramic substructure is printed with a mechanical joint; and combining the first plurality of ceramic substructures using the mechanical joint of each substructure.

Another aspect includes a ceramic support for a catalytic membrane, comprising: a first plurality of ceramic substructures, each having a surface adapted for receiving a membrane and having a plurality of openings, wherein each ceramic substructure is printed with a mechanical joint; wherein the first plurality of ceramic substructures are combined with the mechanical joints of each ceramic substructure.

A further aspect includes an additive manufacturing (AM) method for producing a catalyst membrane support, comprising: printing a first plurality of ceramic substructures, each having a surface adapted for receiving a membrane and a plurality of openings; and combining the first plurality of ceramic substructures using a mortar.

Other aspects include adjacent printed ceramic layers being offset from each other along an x-y plane. Still other aspects include wherein the grid comprises a hexagonal grid and the geometric openings comprise hexagon openings, and wherein each hexagonal grid comprises connectors and vertices that form a set of hexagon structures. Further aspects include a plurality of printed ceramic posts that connect adjacent printed ceramic layers along a z-axis, and wherein each printed post is connected to a vertex of a first hexagon structure in a first layer and an offset vertex of a second hexagon structure in a second layer. Other aspects provide at least four printed ceramic layers, wherein a first and third printed ceramic layer are aligned and a second and fourth printed ceramic layer are aligned, and wherein the posts between the at least four printed ceramic layers are aligned. Furthermore, the connectors and posts may be substantially cylindrical. Still further, the ceramic posts may comprise angled elements that are angled in an x-y-z space relative to the printed ceramic layers.

In other aspects, the geometric openings include at least one of a square opening, a rectangular opening, a triangular opening, a circular opening, or an oval opening.

In some additional aspects, the mechanical joint comprises a tongue and groove component, a peg/hole, a biscuit, a cross-lap feature, a plug, a snap, or a friction feature. Additionally, the surface may include a raised triangular profile and the plurality of openings are at least one of circular, oval, or polygonal. Furthermore, the AM method may include printing a second plurality of ceramic substructures, each having a plurality of openings that differ from the first plurality of ceramic substructures; and combining the second plurality of ceramic substructures beneath the first plurality of ceramic substructures.

All aspects, examples and features mentioned below can be combined in any technically possible way. The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a perspective view of a ceramic catalyst support with a catalytic membrane, according to embodiments of the disclosure.

FIG. 2 shows a view of a catalyst support, according to embodiments of the disclosure.

FIG. 3 shows a top view of a portion of a multilayered staggered catalyst support, according to embodiments of the disclosure.

FIG. 4 is a perspective view of a portion of the multilayered staggered catalyst support of FIG. 3, according to embodiments of the disclosure.

FIG. 5 depicts a flow diagram of an additive manufacturing process according to embodiments.

FIG. 6 shows a side view of an alternate embodiment of a multilayered staggered catalyst support, according to embodiments of the disclosure.

FIG. 7 depicts an isometric view of the support of FIG. 6, according to embodiments of the disclosure.

FIG. 8 depicts a further isometric view of the support of FIG. 6, according to embodiments of the disclosure.

FIG. 9 depicts an isometric view of a support substructure having a triangular profile according to embodiments of the disclosure.

FIG. 10 depicts a cutaway top view of the substructure of FIG. 9, according to embodiments of the disclosure.

FIG. 11 depicts a further alternative embodiment of a support substructure, according to embodiments of the disclosure.

FIG. 12 depicts a top view of the support substructure of FIG. 11, according to embodiments of the disclosure.

FIGS. 13A and 13B depict a side view of the support substructure of FIG. 11 with mechanical joints, according to embodiments of the disclosure.

FIG. 14 depicts a top view of a support using support substructures of FIG. 11, according to embodiments of the disclosure.

FIG. 15 depicts a side view of multi-layer support according to embodiments of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

Certain embodiments will now be described to provide an overall understanding of the principles of the structure, function, manufacture, and use of the methods, systems, and devices disclosed herein. One or more examples of these embodiments are illustrated in accompanying drawings. Those skilled in the art will understand that methods, systems, and devices specifically described herein and illustrated in the accompanying drawings are non-limiting embodiments. Features illustrated or described in connection with one embodiment may be combined with features of other embodiments. Such modifications and variations are intended to be included within the scope of the present disclosure.

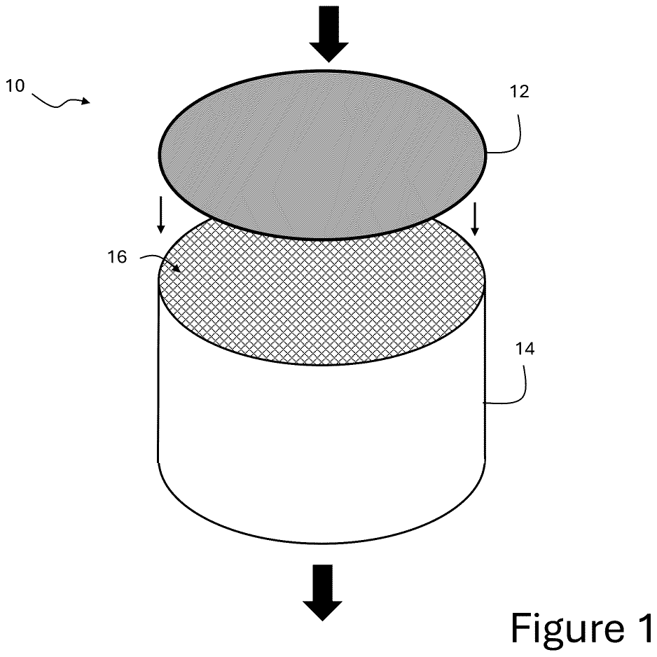

FIG. 1 depicts an exploded overview of a catalyst system 10 that includes a catalytic membrane 12, e.g., a woven catalyst gauze, that mates with a catalyst support 14, e.g., a ceramic catalyst support. Note that the membrane 12 is shown separated from the support 14 in FIG. 1 for the purposes of explanation, however, in practice, it is understood that membrane 12 is placed on top of support 14.

The catalyst support 14 includes an internal structure 16 with openings that allows a gas to pass therethrough. Although shown as a cylindrical structure with a circular interface, it is understood that catalytic system 10 is not limited to a particular configuration and/or interface shape, e.g., the interface could be square, rectangular, oval, etc. In some aspects, support 14 may comprise a set of substructures that can be arranged/connected with other substructures to create the resulting support 14. This for example allows for the printing of manageable sized substructures that can be mated together. For example, a final support 14 may be about four to eight feet in diameter, while the individual substructures 14 may be about 10-30 inches in diameter.

Over the lifetime of a conventional ceramic support 14 and the coupled catalytic membrane 12, a loss of life may be experienced in the catalytic membrane 12 through tearing and chemical spoiling when conventional approaches for implementing and manufacturing ceramic catalyst supports are used. These lifetime issues of the catalytic membrane due to the ceramic support may for example be caused by: (1) thermal shock of the ceramic support, as the high temperature required as well as the reaction being extremely exothermic causes extreme temperature changes, resulting in cracking and geometrical changes; (2) dimpling of the catalytic membrane into the ceramic support caused by the pressure difference across the catalytic membrane and the ceramic support in use; and (3) silica leaching from the ceramic support and reacting with the catalytic membrane causing the catalytic membrane to spoil and the ceramic support to weaken and embrittle due to loss of silica. Aspects of the present disclosure address these issues as well as others.

To address these limitations, the present approach uses an additive manufacturing (AM) process, namely a direct ink writing (DIW) method that allows for the direct production of a ceramic product. Unlike other additive manufacturing methods for ceramics, DIW allows for the respective parts to maintain excellent thermal shock resistance comparable to product manufactured using a freeze-cast manufacturing method, while also gaining additional enhanced properties. For example, direct ink writing allows for smaller hole dimensions and other geometrical complexities, potentially improving catalyst efficiency and reduction of pressure drop to increase system productivity and decrease catalyst dimpling. Further, using DIW, catalyst supports can be manufactured without any silica present, allowing for improved product lifetime and preservation of the catalytic membrane purity. Moreover, no tooling is required, significantly reducing lead times, e.g., from approximately 13 weeks to five weeks.

Direct ink writing (DIW) is a family of additive fabrication methods used to create materials with controlled architecture and composition onto substrates in a sequential manner by moving the material deposition system or the substrate along a predefined path. In DIW, the ceramic slurry “ink” is dispensed out of small nozzles under controlled flow rates and deposited along digitally defined paths to fabricate complex 3D structures layer-by-layer. DIW can be used to create ceramics such as bio-ceramics, composites, concrete, and alkali-activated materials. One advantage of DIW is that it can use high solid loading slurries, which can reduce shrinkage of the product after drying and sintering.

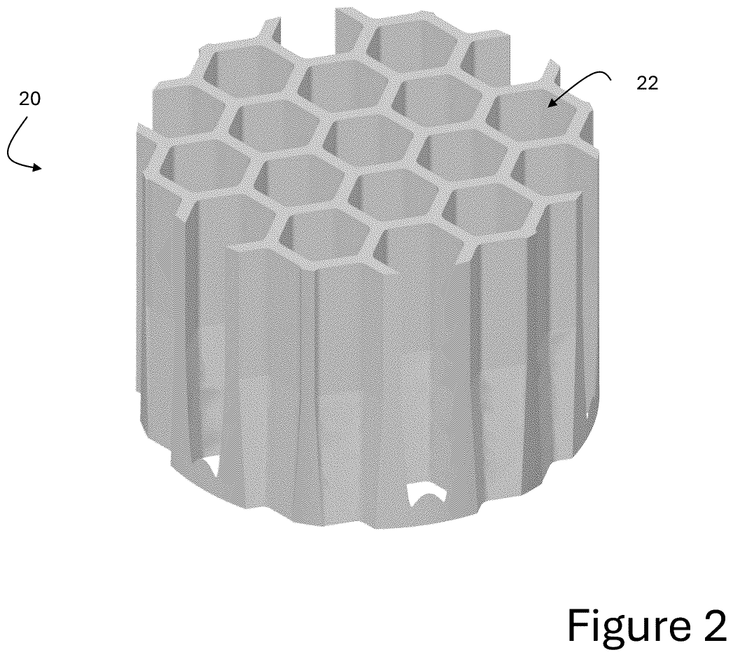

FIG. 2 depicts an isometric view of a portion of a catalyst support 20 having a plurality of openings 22 manufactured using DIW. In this case, each opening includes a hexagonal geometry that extends fully through the support 20. While such designs could for example be manufactured with a freeze-cast method of production, an extrusion method, or plaster casting coupled with a machining step, such manufacturing techniques have various limitations including the inability to implement smaller hole sizes and geometric complexities that could improve catalyst efficiencies, system lifetime, and productivity of the system.

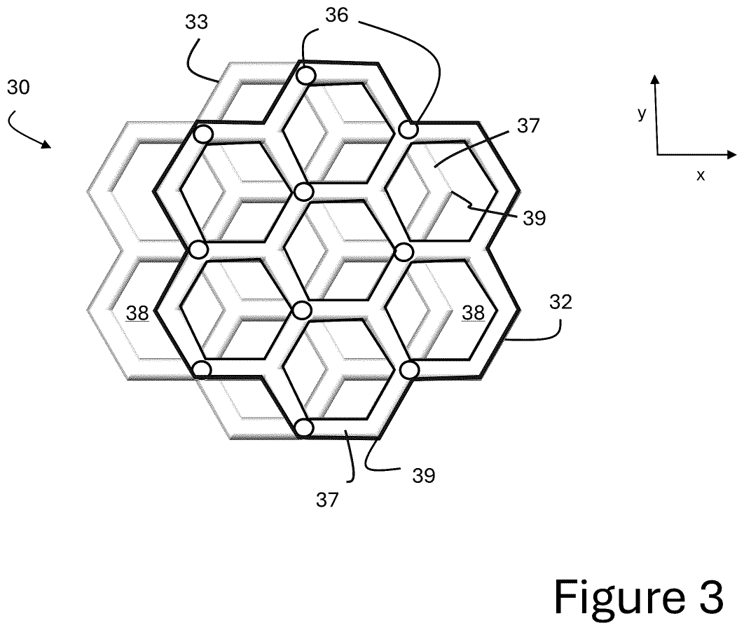

FIG. 3 depicts a top view of a portion of a ceramic catalyst support 30 generated using DIW that provides a relatively complex lattice structure. Depicted in this view is a first (i.e. top) layer 32 and a second layer 33 that have substantially similar geometric configurations. In this embodiment, the two depicted layers 32, 33 are offset or staggered relative to each other along the x-y plane. In this case, both layers 32, 33 comprise a hexagon grid that include connected hexagons, with each hexagon being made up of six connector segments 37 and six vertices 39. Each hexagon within a respective grid provides a hexagonal opening 38 through which a gas can flow. As can be seen, the first layer 32 is offset relative to the second layer 33 such that the openings 38 are misaligned. That is, the hexagon segments 37 and vertices 39 in the second layer 33 interfere with the openings 38 in the top layer 32 along the z-axis. The misalignment of the layers improves performance by limiting the distance the membrane can dimple in the z-axis direction while still minimizing pressure drop. In this embodiment, layers 32, 33 are structurally connected and separated by posts 36 located at offset vertices of layers 32, 33.

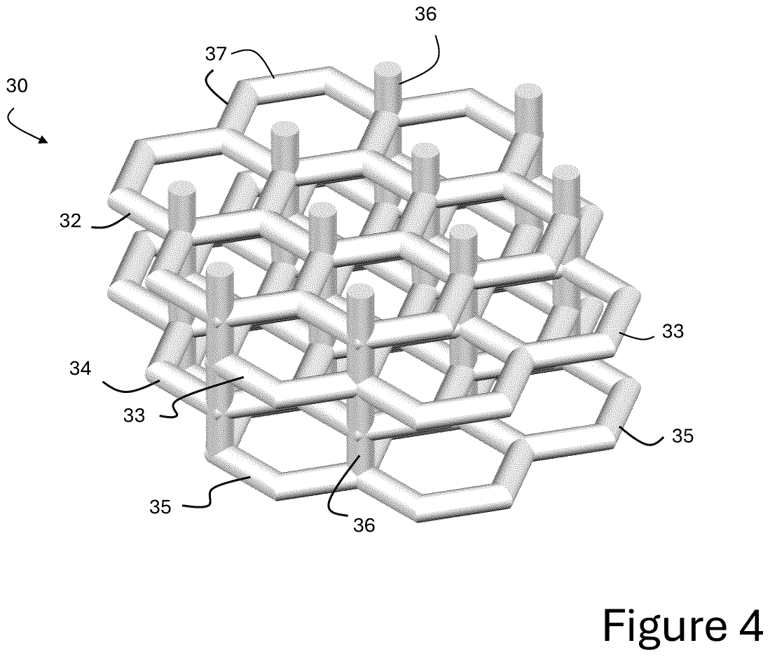

FIG. 4 depicts a three-dimensional view of the ceramic catalyst support 30 of FIG. 3, which shows four layers 32, 33, 34, and 35. In this embodiment, the offsetting of layers is alternated such that adjacent layers are offset with respect to each other. Additionally, every other layer is aligned, i.e., layers 32 and 34 are aligned and layers 33 and 35 are aligned. It is understood that the number of layers and size of each layer (i.e., number of hexagons) can vary depending on the particular application, and what is shown in FIGS. 3 and 4 represents only a portion of a completed support.

As noted above, posts 36 connect with and structurally separate each layer 32, 33, 34, 35. In this case, posts 36 attach perpendicularly to vertices of the hexagons extending along the z-axis. Each hexagon is generally supported by up to three posts 36 and at adjacent layers (e.g., layers 32, 33), posts 36 attach to vertices that are offset from each other in the x-y plane. In the depicted embodiment, posts 36 and connector segments 37 are substantially cylindrical in shape with circular cross-sections. However, it is understood that other post and/or segment shapes/cross-sections could be utilized, e.g., oval, rectangular, triangular, polygonal, twisted, etc. Furthermore, while layers in this embodiment are implemented with a hexagon grid, it is understood that other grid geometries and shapes could be utilized, e.g., a square grid, a circular grid, a triangular grid, other polygon grids, etc. Still further, it is understood that the offsetting of layers can follow different and more complex arrangements. For example, the current embodiment provides an arrangement where alternating layers are offset along a single axis (left to right in the x-axis as shown in FIG. 3). However, offsetting may be implemented for every three (or more) layers. For example, a second layer may be offset x millimeters along a first direction with respect to a first layer, and a third layer is offset x millimeters also along the first direction with respect to the second layer. Furthermore, layers may be offset in different directions in the x-y plane. As also noted, support 30 may provide a substructure that can be connected adjacently to similar substructures to form a larger system.

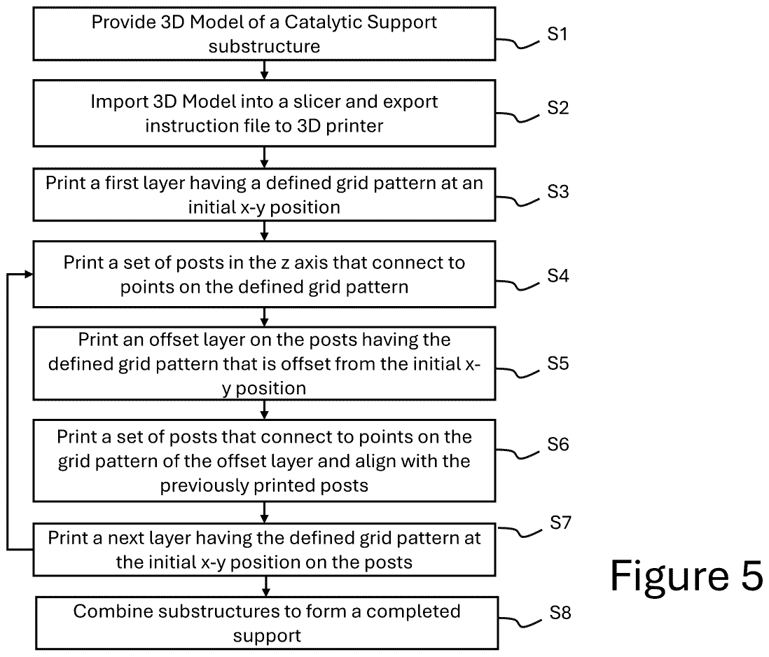

FIG. 5 depicts a flow diagram of an illustrative additive manufacturing (AM) process for manufacturing a ceramic catalytic support 30. The process begins with providing a 3D model of a support substructure at S1 and importing the 3D model into a slicer and exporting an instruction file to a 3D printer at S2. Next, at S3, a first layer having a defined grid pattern (e.g., a hexagon grid) is printed at a location in the x-y plane. At S4, a set of posts are printed along the z axis that connect to points (e.g., vertices) on the defined grid pattern. At S5, an offset layer is printed on the posts and includes the defined grid pattern offset from the initial location in the x-y plane. At S6, a further set of posts are printed that connect to points on the defined grid pattern of the offset layer and align with the previously printed posts. At S7, a next layer is printed having the defined grid pattern at the initial location in the x-y plane. The process then loops back to S4 and repeats until the support substructure is completed. At S8, a set of substructures are combined to form a completed support.

The described lattice structure with offset layering, e.g., shown in FIGS. 3 and 4, printed using DIW has numerous technological advantages. Firstly, because the hole geometry (formed by openings 38) do not include complete through holes, dimpling of the catalytic membrane as it gets forced into the openings 38 of the outer layer is limited, i.e., individual dimples get impeded by the offset layering. The structure also results in minimal pressure drop and increased resonance times between gases and the catalyst. Further, wall thicknesses can be less than 1 mm, and even below 0.04 mm. High aspect ratio hole geometries can accordingly be manufactured. Still further, DIW allows for control of surface roughness and minimization or elimination of sharp edges by filleting, and allows for reduced stress concentration for ceramic structures. This also minimizes locations where the catalytic membrane can catch and rip.

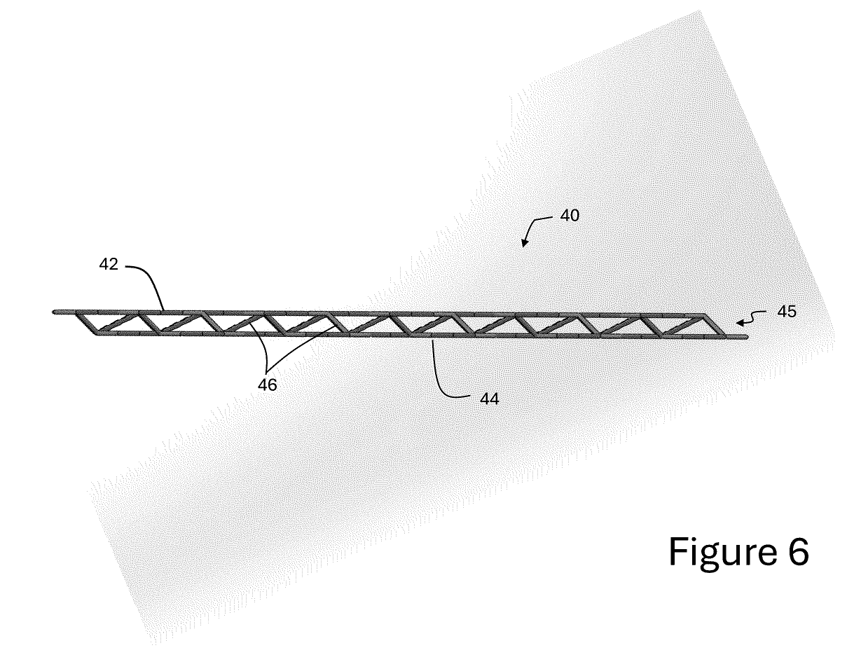

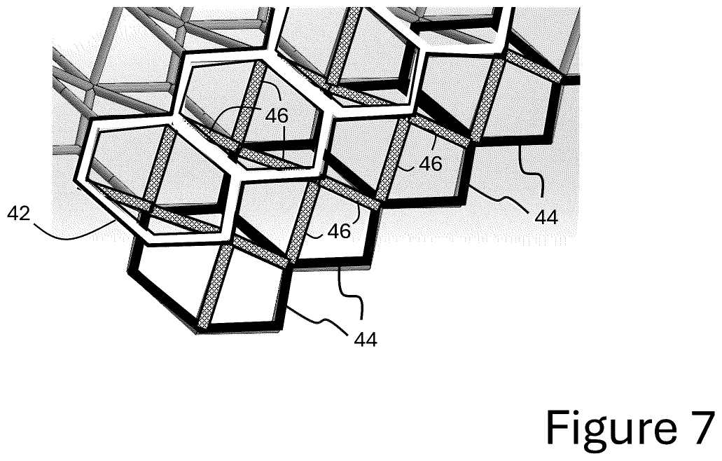

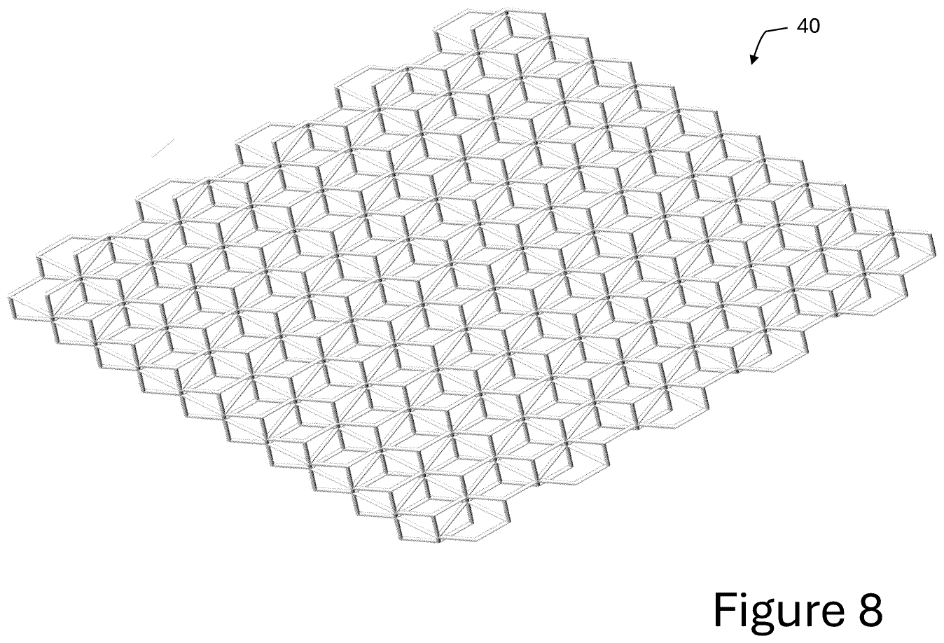

FIGS. 6-8 depict a portion of an alternative lattice structure of a ceramic support 40 with offset layering. FIG. 6 depicts a side view of the support 40 that includes a first layer 42, a second layer 44, and a separating construct 45. Separating construct 45 includes a plurality of angled posts or elements 46 that connect the first and second layers. FIG. 7 depicts a partial isometric view of the support 40. As shown, the first layer 42 includes a first plurality of interconnected hexagon structures, and the second layer 44 include a second plurality of interconnected hexagon structures that are laterally offset from the first plurality of interconnected hexagon structures. The separating construct 45 comprises angled posts 46 that connect hexagon vertices in the first layer 42 with offset hexagon vertices in the second layer 44. Each vertex in a given layer may for example have up to three angled posts that connect with (e.g., every other) vertices of a hexagon structure in an adjacent layer. FIG. 8 depicts a further isometric view of the support 40. It is understood that while FIG. 6-8 depict a lattice structure with two layers 42, 44, more than two layers may be incorporated into a completed structure. Furthermore, it is also understood that support 40 may be manufactured using essentially the same method as described in the flow chart of FIG. 5. However, rather than printing vertical posts in the z-axis, angled posts 46 are printed in the x-y-z axis to obtain the separating construct 45 as shown.

It is understood that while in some embodiments adjacent printed ceramic layers are offset, in other embodiments adjacent printed ceramic layers need not be offset. For example, geometric openings along an x-y plane in a first layer may align from with geometric openings in an adjacent second layer. In other embodiments, adjacent layers may be printed with different types of geometric openings, e.g., square openings on one layer and round openings on another layer.

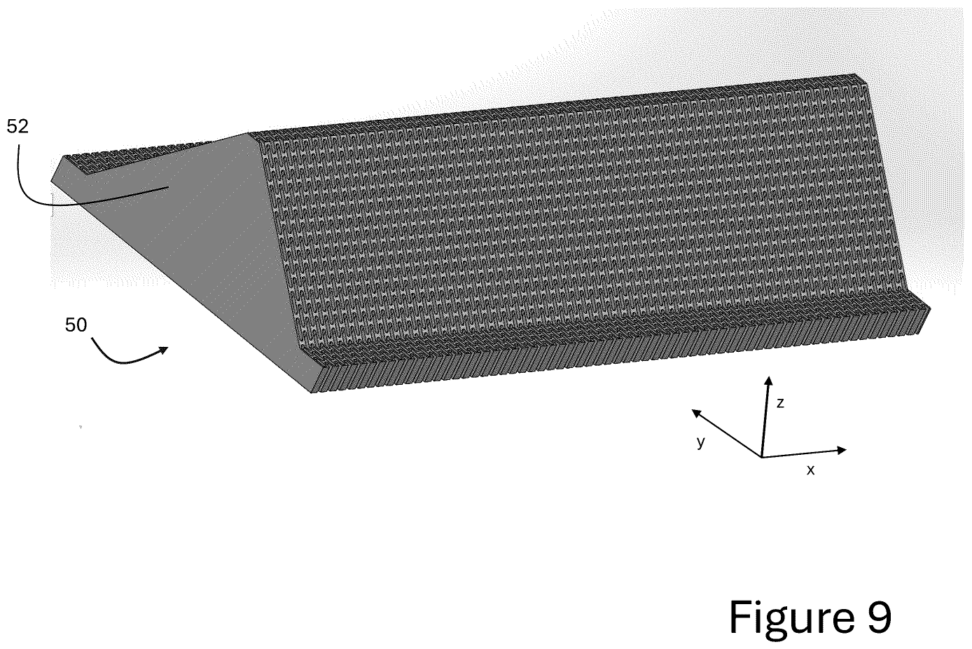

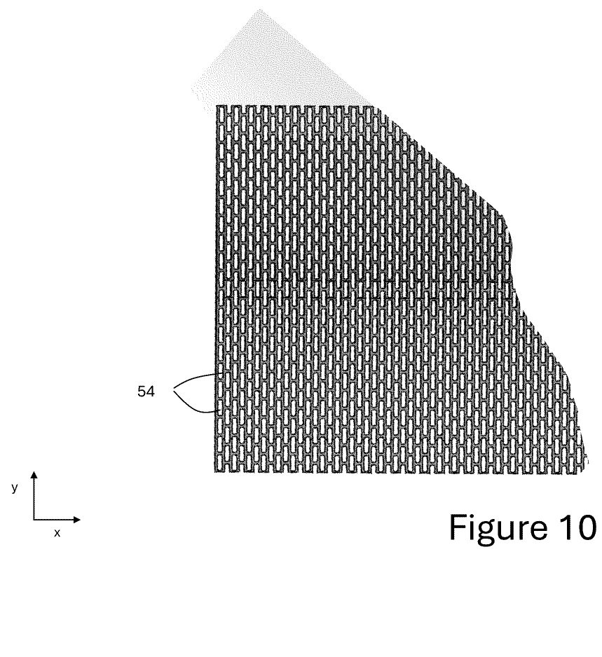

Furthermore, while embodiments of layered support structures with, e.g., hexagon openings, are described herein, such as a hexagon grid pattern or cross-section, it is understood that other opening shapes and arrangements may be utilized, including non-layered arrangements. For example, FIGS. 9-11 depict an example of a catalyst support substructure 50 that utilizes oval openings. As shown in FIG. 9, support substructure 50 has a triangular profile 52, with oval openings that run along the z axis. The triangular profile 52 creates a larger surface area onto which a catalytic membrane can be affixed. FIG. 10 depicts a cut-away top view of the support 50 showing staggered oval shaped openings 54 that provide flow along the z-axis. The staggered oval openings 54 provide high amount of open surface area using relatively small opens.

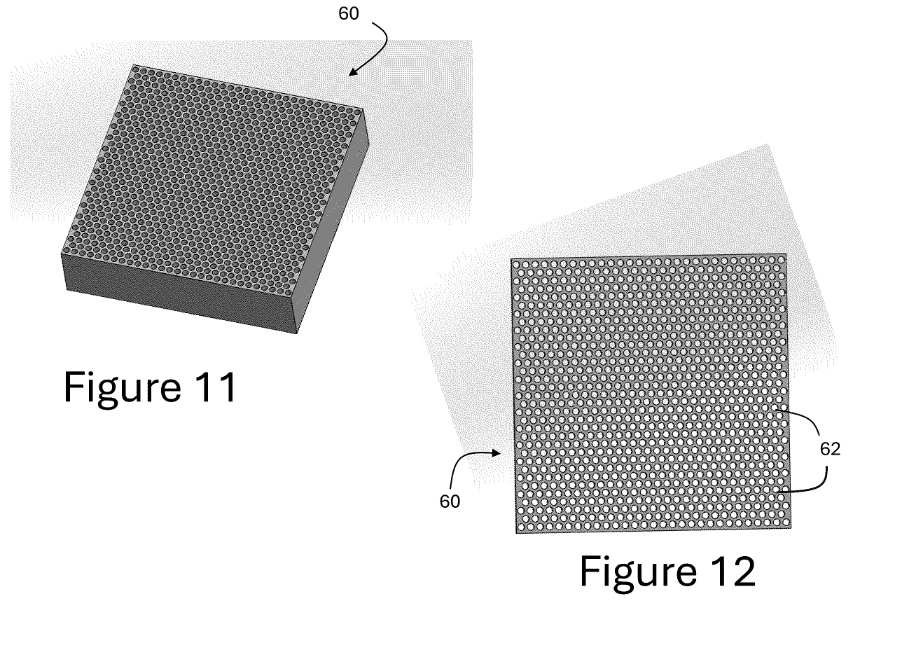

FIGS. 11-12 depict yet a further embodiment of a square support 60 that utilizes offset cylindrical holes 62. Similar to the oval openings, cylindrical holes 62 provide a high amount of open surface area using relatively small opens.

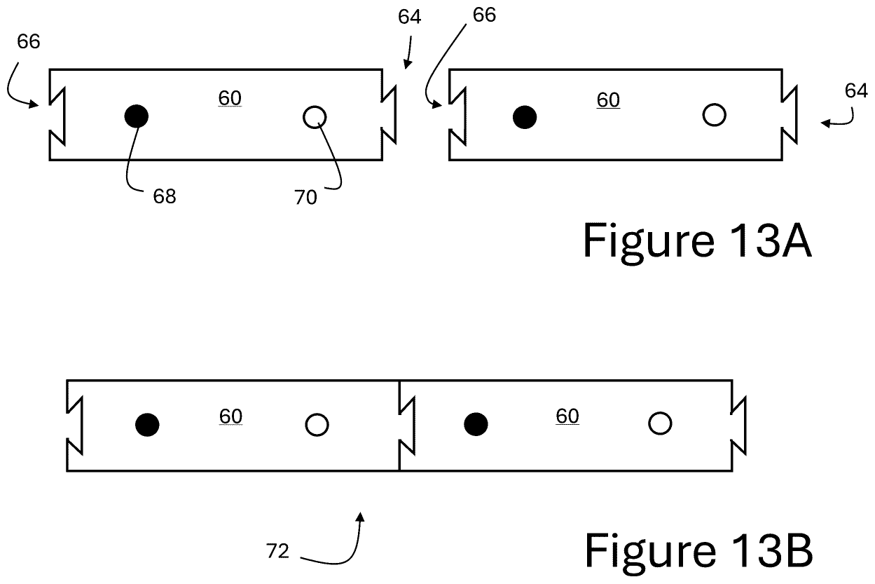

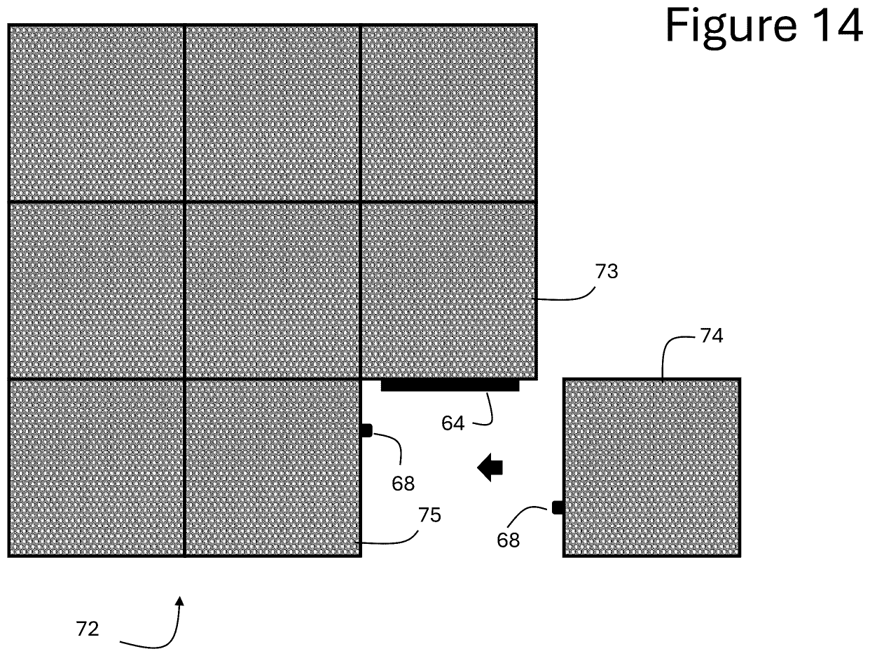

As noted, the various structures described herein may comprise substructures that are combined with other substructures to form a completed support. This approach addresses inherent size limitations with printing technology when forming large ceramic supports (e.g., 4-8 feet in diameter). Even as the print envelope of 3D printers expands and the technology improves, maintaining specific geometries and flatness to print larger supports may not be achievable. Substructures may be combined together in any manner, e.g., using mechanical joints, mortar, etc. FIGS. 13A and 13B depict an illustrative mechanical joint that uses tongue and grooves 64, 66 and pegs/holes 68, 70 for joining the substructures (e.g., support 60 of FIGS. 11-12 shown in a side view). As shown in FIG. 13A, each substructure 60 is printed with a tongue 64 and groove 66, as well as a peg 68 and hole 70. As shown in FIG. 13B, adjacent substructures can be mechanically joined to form a larger support 72. FIG. 14 shows a top view of support 72 being assembled. In this view, the groove (not shown) of substructure 74 is slidably engaged to the tongue 64 of an adjacent substructure 73. Pegs 68 in substructures 74 and 75 align with associated holes (not shown) to further maintain the mechanical rigidity of support 72. Other types of mechanical connections, e.g., cross lapping, biscuits, snaps, plugs, friction features, etc., could likewise be utilized. Furthermore, printed substructures may comprise other types of shapes, e.g., hexagon, rectangles, circular, etc., and different shapes and sizes may be implemented for a given support.

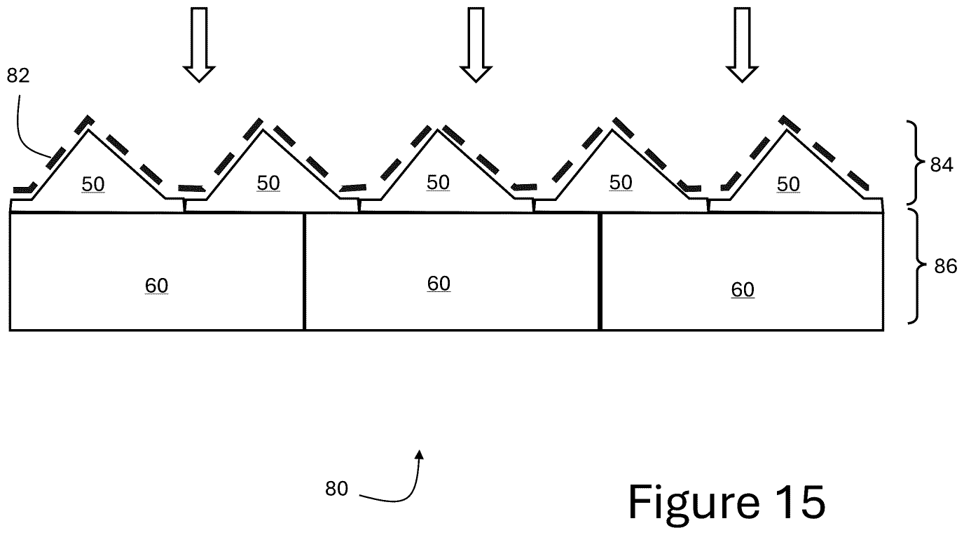

FIG. 15 depicts an illustrative multilayer support 80 that utilizes two types of substructures 50, 60. Substructures 50, which are shown in more detail in FIGS. 9 and 10, are arranged side-by-side to form a top layer 84 onto which membrane 82 is placed. Substructures 60, which are shown in more detail in FIGS. 11-13A, B, are also arranged side-by-side to form a secondary layer 82 beneath the top layer 84. Multi-layer structures such as that shown in FIG. 15 may deploy a top structure 84 with more complex openings, e.g., to improve performance, and a bottom structure 86 with less complex openings, e.g., for lower cost and/or structural integrity.

The ceramic supports described provide a catalyst system that overcomes prior technical issues using solely convention manufacturing techniques.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “About,” as applied to a particular value of a range, applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application and to enable others of ordinary skill in the art to understand the disclosure for various embodiments with various modifications as are suited to the particular use contemplated.

What is claimed is:

1. A catalyst support, comprising:
a plurality of printed ceramic layers, wherein each printed ceramic layer includes a grid having a plurality of geometric openings along an x-y plane, and wherein adjacent printed ceramic layers are separated from each other along a z-axis; and
a plurality of printed ceramic posts that connect adjacent printed ceramic layers.

2. The catalyst support of claim 1, wherein adjacent printed ceramic layers are offset from each other such that the geometric openings of adjacent printed ceramic layers are misaligned.

3. The catalyst support of claim 2, wherein adjacent printed ceramic layers are offset from each other along an x-y plane.

4. The catalyst support of claim 3, wherein the grid comprises a hexagonal grid and the geometric openings comprise hexagon openings.

5. The catalyst support of claim 4, wherein the plurality of printed ceramic posts that connect adjacent printed ceramic layers extend along a z-axis.

6. The catalyst support of claim 5, wherein each hexagonal grid comprises connectors and vertices that form a set of hexagon structures.

7. The catalyst support of claim 6, wherein each printed post is connected to a vertex of a first hexagon structure in a first layer and an offset vertex of a second hexagon structure in a second layer.

8. The catalyst support of claim 7, comprising at least four printed ceramic layers, wherein a first and third printed ceramic layer are aligned and a second and fourth printed ceramic layer are aligned.

9. The catalyst support of claim 8, wherein the posts between the at least four printed ceramic layers are aligned.

10. The catalyst support of claim 6, wherein the connectors and posts are substantially cylindrical.

11. The catalyst support of claim 3, wherein the ceramic posts are angled in an x-y-z space relative to the printed ceramic layers.

12. The catalyst support of claim 1, wherein the geometric openings include at least one of a square opening, a rectangular opening, a triangular opening, a circular opening, or an oval opening.

13. An additive manufacturing (AM) method for producing a catalyst support, comprising:
printing a first ceramic layer having a defined grid with a plurality of geometric openings along an x-y plane;
printing a plurality of ceramic posts having first ends that connect to and extend along a z-axis from the first ceramic layer; and
printing a second ceramic layer having the defined grid that connect to second ends of the ceramic posts.

14. The AM method of claim 13, wherein the second ceramic layer is offset along the x-y plane from the first ceramic layer such that the geometric openings of the first and second ceramic layers are misaligned.

15. The AM method of claim 14, wherein the defined grid comprises connectors and vertices that form a set of hexagonal structures with hexagon openings.

16. The AM method of claim 15, wherein each ceramic post is connected to a vertex of a first hexagonal structure in the first ceramic layer and an offset vertex of a second hexagonal structure in the second ceramic layer.

17. The AM method of claim 14, further comprising printing at least four ceramic layers, wherein a first and third printed ceramic layer are aligned and a second and fourth ceramic layer are aligned.

18. The AM method of claim 17, wherein the posts between the at least four printed ceramic layers are aligned.

19. The AM method of claim 15, wherein the connectors and posts are substantially cylindrical.

20. The AM method of claim 14, wherein the ceramic posts comprise angled elements that are angled in an x-y-z space relative to the first and second ceramic layers.

21. The AM method of claim 14, wherein the geometric openings include at least one of a square opening, a rectangular opening, a triangular opening, a circular opening, or an oval opening.

22. An additive manufacturing (AM) method for producing a catalyst support, comprising:
printing a first plurality of ceramic substructures, each having a surface adapted for receiving a catalytic membrane and a plurality of openings, wherein each ceramic substructure is printed with a mechanical joint; and
combining the first plurality of ceramic substructures using the mechanical joint of each substructure.

23. The AM method of claim 22, wherein the mechanical joint comprises a tongue and groove component, a peg or hole, a biscuit, a cross-lap feature, a plug, a snap, or a friction feature.

24. The AM method of claim 22, wherein the surface includes a raised triangular profile.

25. The AM method of claim 22, wherein the plurality of openings are at least one of circular, oval, or polygonal.

26. The AM method of claim 22, further comprising:
printing a second plurality of ceramic substructures, each having a plurality of openings that differ from the first plurality of ceramic substructures; and
combining the second plurality of ceramic substructures beneath the first plurality of ceramic substructures.

27. A ceramic catalyst support, comprising:
a first plurality of ceramic substructures, each having a surface adapted for receiving a catalytic membrane and a plurality of openings, wherein each ceramic substructure is printed with a mechanical joint;
wherein the first plurality of ceramic substructures are combined with the mechanical joints of each ceramic substructure.

28. The ceramic catalyst support of claim 27, further comprising:
a second plurality of ceramic substructures, each having a plurality of openings that differ from the first plurality of ceramic substructures;
wherein the second plurality of ceramic substructures are combined beneath the first plurality of ceramic substructures.

29. An additive manufacturing (AM) method for producing a catalyst support, comprising:
printing a first plurality of ceramic substructures, each having a surface adapted for receiving a catalytic membrane and a plurality of openings; and
combining the first plurality of ceramic substructures using a mortar.
